(19) United States
(12) Patent Application Publication
(10) Pub. No.: US 2011/0231355 A1
(43) Pub. Date: Sep. 22, 2011

(54) INTELLIGENT UBIQUITOUS-CITY MIDDLEWARE APPARATUS AND THE U-CITY SYSTEM HAVING THE SAME

(75) Inventor: Yong Woo LEE, Seoul (KR)

(73) Assignee: UNIVERSITY OF SEOUL FOUNDATION OF INDUSTRY ACADEMIC COOPERATION, Seoul (KR)

(21) Appl. No.: 13/053,411

(22) Filed: Mar. 22, 2011

Related U.S. Application Data
(60) Provisional application No. 61/316,357, filed on Mar. 22, 2010.

(51) Int. Cl. G06N 5/04

(52) U.S. Cl. 706/46

(57) ABSTRACT

An intelligent U-City middleware apparatus and the U-City adopting the same are disclosed. The intelligent U-City middleware apparatus provides intelligent service based on context-awareness and a variety of intelligent ubiquitous convergence services for the applications of U-City. It is composed of four layers: Common Device Interface Layer, Context-aware Computing Layer, Ubiquitous Core Computing Layer and Common Application Interface Layer. The layers cooperate to give intelligent ubiquitous convergence services and provide the advantages of layered architecture.

### CROSS-REFERENCE TO RELATED PATENT APPLICATIONS

This application claims the benefit of a provisional application No. 61/316,357, filed on Mar. 22, 2010, in the United States Patent and Trademark Office, the disclosure of which is incorporated herein in its entirety by reference.

### BACKGROUND OF THE INVENTION

1. Field of the Invention

The present invention relates to a ubiquitous-city (“U-City”, hereinafter) middleware apparatus and the U-City system having the same which supports an infrastructure for the intelligent ubiquitous environment for a U-City by providing not only dynamic and intelligent service execution based on context-awareness but also variety of converged services.

2. Description of the Related Art

What is the U-city? A U-City refers to a city created through a convergence among the ICT (Information and communication technologies), construction technologies, urban engineering. It is the combination of the ubiquitous computing, citizens, activities, facilities and land. In the U-city, all information systems are linked, and virtually everything is linked to an information system. U-city is an intelligent and self-innovative city and is realized by applying intelligence, cyber geo-reference and network. It is different from e-society.

Ubiquitous computing is a major IT trend to prepare IT innovation. With it, we are seeking the way to satisfy our desire to enjoy IT services with any device, anytime, anywhere. With the IT innovations, we even dream to build smart or intelligent cities, that is, the U-city, nowadays. It is defined to be a post-desktop model of human-computer interaction in which information processing has been thoroughly integrated into everyday objects and activity [1]. It plays as a fundamental technology for the U-city which provides various integrated services for the intelligent city.

In order to cope with the various activities in the U-City effectively, decisions should be made in a timely manner by the efficient cooperation among single individuals or groups or by the real time computation of data relevant to the decision. Even though the existing ubiquitous systems provide users with intelligent services, they are not suitable for U-City since they cannot meet the U-City activity in a flexible and timely manner.

There are a number of projects[2, 3, 4, 5, 6, 7, 8] that provide middleware support for ubiquitous computing environments. The numbers in brackets refer to the number of references listed below. As control middleware, there are HAVi[9, 10, 11], Jini[12, 13], UPnP[14, 15], LonWork[16], etc. As context-aware middleware, there are RCSM[17], Gaia[18, 19, 20, 21], Aura[22], SOCAM[23], CAMUS[24] and Accord[25]. As QOS-aware middleware, there are [26, 27, 28, 29, 30], etc.

Gaia transforms physical spaces and their ubiquitous computing devices into a programmable computing system and manages the tasks common to all applications built for physical spaces. However, Gaia is not for U-City. Gaia uses framework approach but we use layer approach. Gaia is based on CORBA. Our system does not use CORBA but uses web service technology which is more advanced than CORBA.

The Aura Project has a unique concept of personal Aura that acts as a proxy for the mobile user it represents and has several nice features such as marshaling appropriate resources to support the user's task when a user enters a new environment and capturing the constraints that the physical context around the user imposes on the tasks requiring several information sources and applications. Oxygen targets to combine specific user with system technologies to enable pervasive, human-centered computing. For it, Oxygen uses speech and vision technologies, automation, individualized knowledge access and collaboration technologies to perform a wide variety of tasks that users want to do in the ways they like to do them. Service-Oriented Context-Aware Middleware (SOCAM) is claimed to be a special architecture designed to have the development-time advantage for context-aware applications, provides Context Provider, Context Interpreter and Service Locating Service and uses the context ontology that represents current entities states and is separated into two areas such as upper ontology and domain-specific ontology.

However, GAIA, AURA, Oxygen and SOCAM are middlewares for relatively smaller ubiquitous systems, that is, these middlewares are not designed to support full scale U-City applications but relatively smaller scale ubiquitous applications such as intelligent home application or intelligent building applications.

Yet, there is no U-City middleware apparatus which is designed to support full scale ubiquitous city and no U-City system which use it.

### SUMMARY OF THE INVENTION

The present invention provides a U-City middleware which supports U-City (System and applications) and by providing not only dynamic service execution based on context-awareness but also variety of converged services.

The present invention also provides the three tier U-City system which has the U-City middleware apparatus.

According to an aspect of the present invention, there is provided an intelligent U-City middleware apparatus for realizing a service for a U-City system having plural sensors with individual sensor characteristics and plural ubiquitous remote resources with individual resource characteristics. The intelligent U-City middleware apparatus comprises a common device interface component receiving the individual sensor signals from the sensors and converting the received individual sensor signals to common sensor signals; a context-aware computing component analyzing the common sensor signals to infer current context information of the u-city system; and a ubiquitous core computing component receiving the context information from the context-aware computing module and configured to intelligently determine a service to be realized corresponding to the received context information. Furthermore, the intelligent U-City middleware apparatus further comprises: a common application interface component converting information related to the service, such that the information is compatible with any application executed in terminals with different operation environments, and providing the converted result to the terminals. Also, ubiquitous core computing component comprises a Grid computing manager managing Grid computing functions. Or the ubiquitous core computing component comprises a cloud computing manager managing cloud computing functions. Furthermore, the context-aware computing module comprises: a context repository storing context domains and context ontology instances; a context interpreter receiving the common sensor signals and converting the received common sensor signals to context ontology instances; a context aggregator combining the context ontology instances received from the context interpreter and providing a high-level context from low-level contexts; a context analyzer inferring the context information from the high-level context by using predefined rules based on the domain ontology; and a context provider providing the inferred context information to the ubiquitous core computing module. According to one embodiment of the present invention, the ubiquitous core computing component comprises: a context manager receiving the context information and converting the context information to a format used for service discovery; a service manager finding a service which best-matches the context information; a task manager analyzing the services from the service manager and deploying the services to target systems; and an environment manager setting communication environment parameters in response to a request from the task manager. Preferably, the ubiquitous core computing component comprises: a computer based cooperative work functions which enable applications or services to be realized by the entities in a collaborative manner.

According to another aspect of the present invention, there is provided a U-City system having plural sensors with individual sensor characteristics and plural ubiquitous remote resources with individual resource characteristics. The U-City system comprises a feeling tier having the U-City infrastructure including sensors and remote resources; an intelligent U-City middleware apparatus receiving individual sensor signals from the feeling tier, inferring current context information of the U-City system from the received sensor signals, and determining and realizing a service to be executed corresponding to the context information in an intelligent manner; and a presentation tier allowing having human computer interaction and, therefore, displaying information related to the service and configured to allow the intelligent U-City middleware apparatus to control the remote resources. According to the present invention, the intelligent U-City middleware apparatus comprises: a common device interface component converting the individual sensor signals received from the feeling tier to common sensor signals; a context-aware computing component analyzing the common sensor signals to infer current context information of the u-city system; a ubiquitous core computing component receiving the context information from the context-aware computing module and configured to intelligently determine the service to be realized for the u-city system corresponding to the received context information; and a common application interface component converting information related to the service, such that the information is compatible with any application executed in terminals with different operation environments, and providing the converted result to the terminals.

### BRIEF DESCRIPTION OF THE DRAWINGS

The above and other features and advantages of the present invention will become more apparent by describing in detail exemplary embodiments thereof with reference to the attached drawings in which:

FIG. 1 schematically illustrates architecture of the Intelligent U-City Middleware according to an embodiment of the present invention;

FIG. 2 schematically illustrates the operation of the context-aware computing included in FIG. 1;

FIG. 3 schematically illustrates the operation of the ubiquitous core computing included in FIG. 1;

FIG. 4 schematically illustrates the operation of the OWL-S translator;

FIG. 5 schematically illustrates the operation of the service manager; and

FIG. 6 shows an example of a service ontology for U-City applications.

### DETAILED DESCRIPTION OF THE INVENTION

The present invention will now be described more fully with reference to the accompanying drawings, in which exemplary embodiments of the invention are shown.

The Architecture of Intelligent U-City Middleware Apparatus

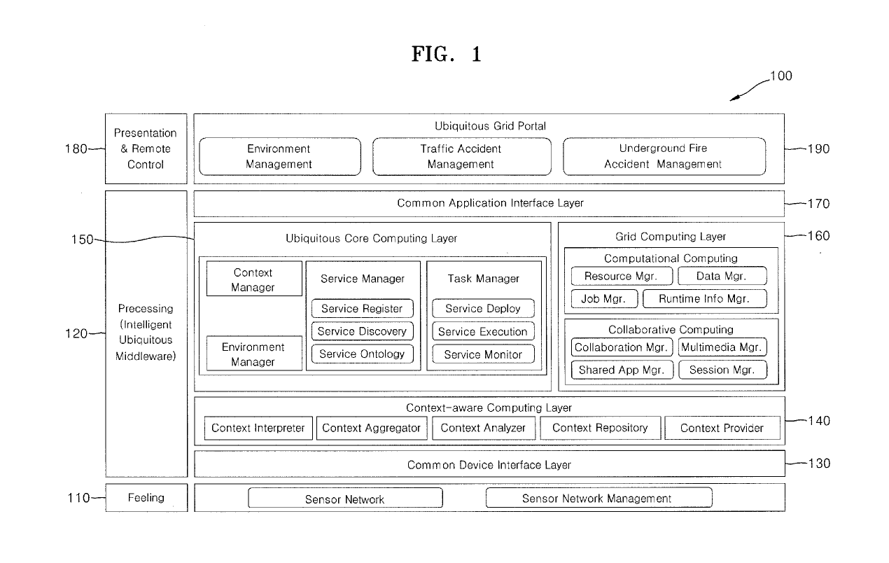

FIG. 1 schematically illustrates architecture of the Intelligent U-City Middleware according to an embodiment of the present invention.

The intelligent U-City middleware apparatus according to the present invention provides a data acquisition interface to sensors and ubiquitous sensor networks and includes an inference engine that can process the collected data to make context-ware, that is, intelligent decision. Therefore, optimal operations can be invoked and proper information is generated by using the intelligent ubiquitous middleware apparatus. It also supports Grid computing and cloud computing so that the demand for high performance computing can be smoothly satisfied and Access Grid so that the scattered researchers throughout Seoul Metropolitan area can cooperate gracefully. Any devices can be transparently connected, as it is, to the intelligent U-City middleware apparatus through the Common Interface Layer. It consists of four layers: Common Device Interface Layer 130, Context-aware Computing Layer 140, Ubiquitous Core Computing Layer 150 and Common Application Interface Layers 170 as shown in FIG. 1.

In the following sections, we present the design of each layer of intelligent ubiquitous middleware apparatus in detail respectively and show that it can provide modularity and expansibility through the design of multi-layer structure and it reduces complicatedness of the system and increases reusability of components through abstraction in each layer.

Common Device Interface Layer

The Common Device Interface Layer 130 provides a common interface to feeling devices such as sensors and various kinds of U-City devices. By doing so, the system 100 can accommodate many different types of U-City infra devices in uniformed way as much as possible. Since the Common Device Interface 130 supports variable sensor network data-sinks and protocols, it can be the central gateway for the multiple sensor networks built on the use of collecting sensor data. The Common Device Interface 130 consists of several adapters that define the basic features required to manage received sensing data. Because the frequent transmit of data influences latency to overall system, all data stream is controlled under the terms of specified time interval. Adapter collects data to its buffer and sends it to all listeners at a time. The Adapter also manages listeners that require time-dependent data to interpreter the context information.

Context-Aware Computing Layer

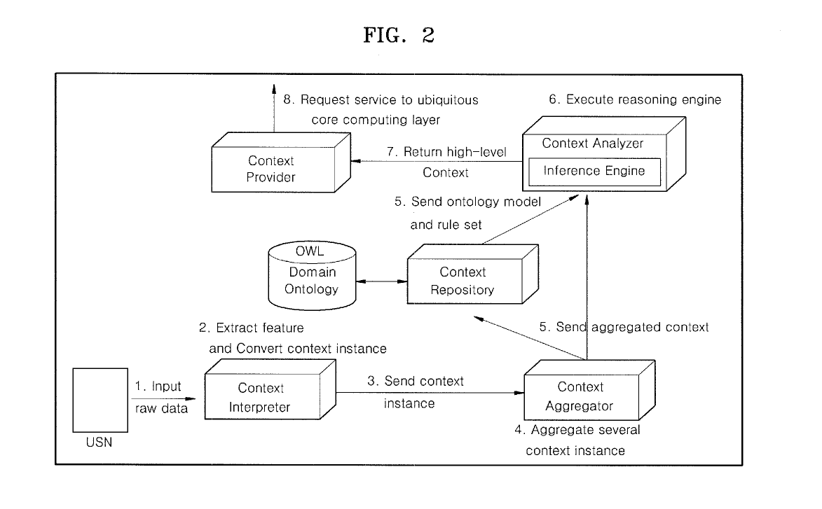

The Context-aware Computing Layer 140 processes data obtained through sensor network and provides the intelligent context. Its key feature lies in its ability to define the context based on concept of specific domain ontology, interpret and aggregate the data through sensor network after context extraction and reason about various contexts. Through the reasoning process, high-level contexts can be derived from low-level ones. The Context-aware Computing Layer 140 consists of 5 components: Context Interpreter, Context Aggregator, Context Analyzer, Context Repository and Context Provider. FIG. 2 shows the components of Context-aware Computing Layer and their interaction. However the name and number of modules can be varied without changing the operational mechanism.

The Context Interpreter obtains raw data from various sensors in heterogeneous formats such as user's positions, temperature and so on and converts them into context ontology instances using domain ontology so that other components can share and reuse them. Context Aggregator combines related contexts from various Context Interpreters to provide high-level contexts by interpreting low-level contexts. One context data element is equivalent to one individual of the context domain-ontology model. Context Aggregator collects these individuals into one ontology data model that contains classes and instances graphs. Context Analyzer provides deduced contexts based on domain ontology by specifying different inference rules, preloading them into the appropriate inference engine. It constructs full relationships among the received context information and produce service area context according to the pre-known facts and rules.

The Context Repository stores context domain ontologies and instances according to the application domain and allows other components to query, add, delete or modify context knowledge stored in the context history. Context Provider requests a service by providing the inferred context to the service discovery component, which in turn searches an appropriate service based on service ontology. It produces minimal set of context information for invoking new service unit.

Ubiquitous Core Computing Layer

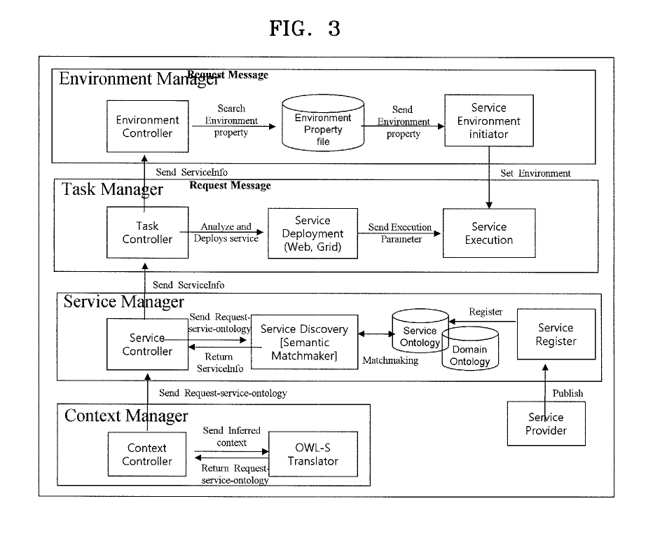

The Ubiquitous Core Computing Layer 150 performs intelligent services such as automatic service discovery, automatic service deployment and automatic service execution based on inferred contexts offered by the Context-aware Computing Layer in order to provide an automatic computing environment and make applications or services used everywhere in a timely and cooperative way. It converges information from a variety of different devices and environments in order to provide predefined services in U-City applications such as Environment Management, Traffic Accident Management, etc. It is composed of 4 components: Context Manager, Service Manager, Task Manager and Environment Manager as shown in FIG. 3.

Ubiquitous Core Computing Layer uses semantic matchmaker that is based on service ontology to discover services optimal to the inferred information. Context Manager translates the inferred context information of what, where and when (eventType, Location, Time) into the OWL format of service ontology in order to be used for service discovery. Inferred context information requests services as the service requester. For example, inferred context information of fire accident requests the service which sends the emergency call or alerting information to a nearby fire station, emergency control center, a police office, a hospital, etc. Therefore, OWL-S Translator translates the inferred context information into the request-service-ontology format which consists of service profile, service process, service grounding.

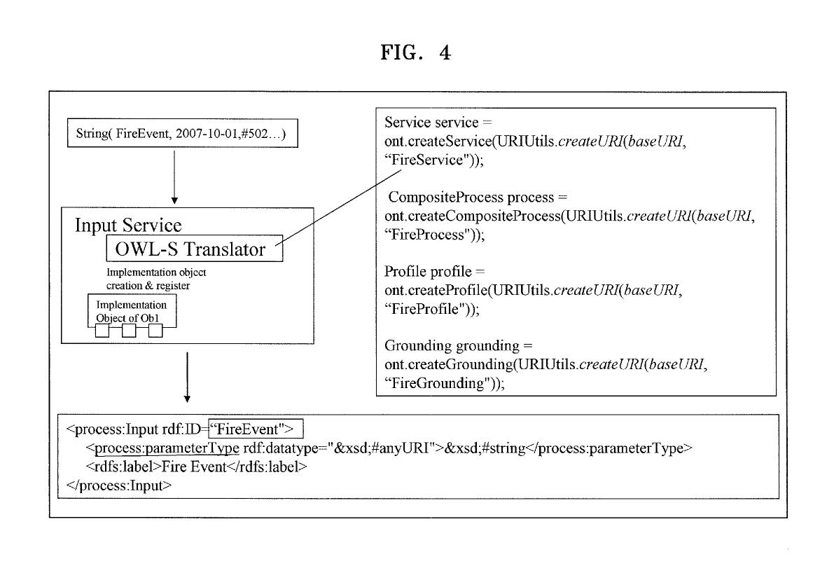

FIG. 4 shows the translation procedure of the OWL-S Translator.

The translation procedure is as follows.

(1) Service Profile is Created.
ServiceName instance and the range of has What property is created for eventType.
The range of hasWhere property is created for Location.
The range of hasTime property is created for time.

(2) Service Process is Created.
ProcessName instance is created for eventType.
The range of hasInput property is created for eventType.

(3) Service Grounding is Created.

Context Manager sends Service Manager the request-service-ontology translated by OWL-S Translator. Service Manager finds the target service which the best matches the inferred context information and sends service discovery component the request-service-ontology received from Context Manager.

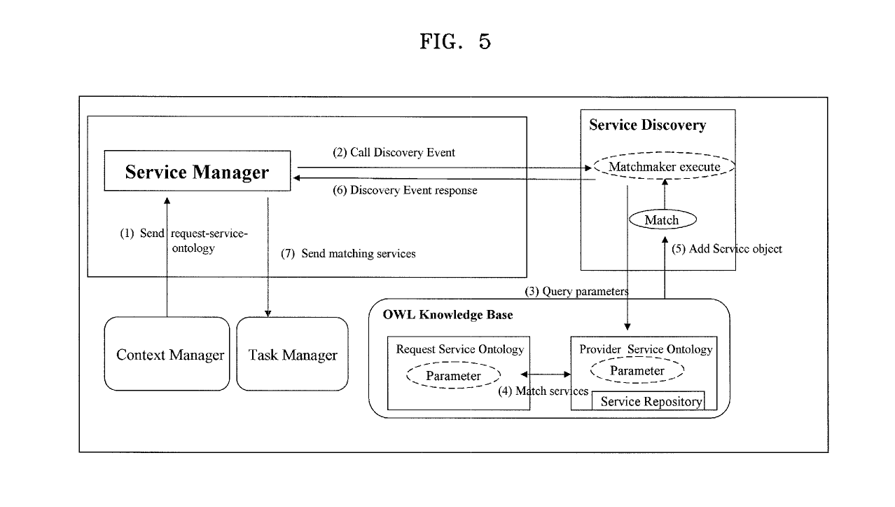

FIG. 5 shows the operation of Service Manager.

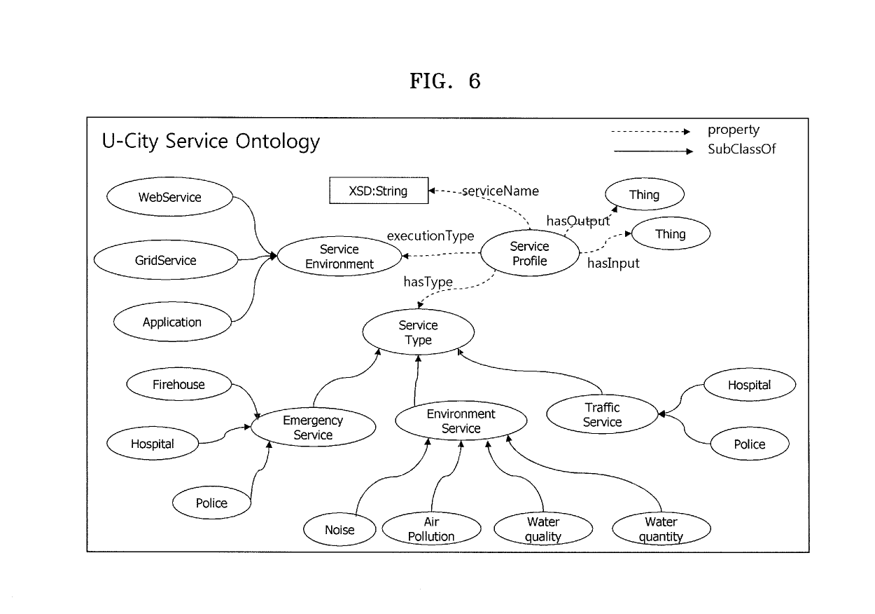

FIG. 6 shows the service ontology for U-City applications.

Semantic matchmaker seeks provider services which match the request service, using service ontology based matching mechanism: it extracts the process parameters from request-service-ontology and from provider-service-ontology respectively. The list of the matched service includes the name of service, the name of process, binding information, etc. Matchmaker works as follows.

(1) Matchmaker calls findRequest which extracts process parameters from request-service-ontology

(2) Matchmaker calls findProvider which extracts process parameters from provider-service-ontology

(3) Matchmaker calls getMatchType which matches process parameters extracted from request-service-ontology with process parameter extracted from provider-service-ontology.

(4) Matchmaker adds to ArrayList the matching result of procedure (3) such as Match.EXACT, Match.SUBSUME and Match.RELAXED, excluding the Match.FAIL.

Ubiquitous Core Computing Layer can have either Grid computing facilities or cloud computing facilities or both of them inside. Grid computing facility and cloud computing facility are used to provide computing powers to the process in Ubiquitous Core Computing Layer. FIG. 7 shows an example of performance monitoring in Grid computing. It is composed of 4 modules: Resource Manager, Data Manager, Job Manager and Runtime Information Manager for resource allocation, file transfer, job execution and information collection respectively. However the name and number of modules can be varied without changing the operational mechanism.

For Collaborative Computing, the Collaborative Computing component provides an environment which allows cooperation such as the analysis, agreement and discussion among people with a lot of data using Access Grid. It has the modules which manage the information of session and people joining the session and share applications or services among the users and control the multimedia including audio and video. It is composed of four managers: Collaboration Manager, Session Manager, Application Sharing Manager and Multimedia Manager.

Common Application Interface Layer

The Common Application Interface Layer 170 provides a common interface to applications in U-City portals. By doing so, the system 100 can manage various kinds of applications with common interface and can accommodate many different types of user devices such as desk-top computers and mobile devices in uniformed way as much as possible.

We have described the design of the intelligent U-City middleware apparatus which supports an U-City infrastructure.

Our U-City middleware has the following outstanding benefits. First, it provides common device interface. Since we designed it to support variable sensor network data-sinks and protocols, it can be used as the common gateway for various kinds of sensors and ubiquitous sensor networks which collect sensed data. Second, we use ontology-based intelligent inference engine which provides context-aware, that is, intelligent information using the sensed data through the common device interface. Third, we provide a user-transparent infrastructure that generates and provides intelligent services, which are invisible to users, to various applications such as the environment management applications, the traffic accident management applications and the underground fire accident management applications. Fourth, we support Grid computing and cloud computing so that it can smoothly satisfy applications which require real-time high performance computing. Fifth, we support computer supported cooperative work (CSCW) through Access Grid which we know the best choice currently and a next generation CSCW. Sixth, we support to control remote devices in real-time mode so that remote control devices such as fire doors and other emergency devices can be controlled remotely in real-time mode. Seventh, there exist the advantages of layered architecture since our middleware is designed to have 4-layer architecture. Lastly and eighth, the intelligent ubiquitous middle apparatus can directly be connected to easy-to-use, yet convenient, user interfaces, the U-City portal.

The intelligent U-City middleware apparatus support various kinds of U-city applications and shortens the period and expense to develop the U-city applications.

The invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, etc. The computer readable recording medium can also be distributed over network coupled computer systems so that the computer readable code is stored and executed in a distributed fashion. Also, functional programs, codes, and code segments for accomplishing the present invention can be easily construed by programmers skilled in the art to which the present invention pertains.

While this invention has been particularly shown and described with reference to preferred embodiments thereof, it will be understood by those skilled in the art that various changes in form and details may be made therein without departing from the spirit and scope of the invention as defined by the appended claims. The preferred embodiments should be considered in descriptive sense only and not for purposes of limitation. Therefore, the scope of the invention is defined not by the detailed description of the invention but by the appended claims, and all differences within the scope will be construed as being included in the present invention.

### REFERENCES

1. http://en.wikipedia.org/wiki/Ubiquitous_computing, referenced in January, 2008.
2. http://oxygen.csail.mit.edu/Overview.html, referenced in January, 2008.
3. Manuel Román, Christopher K. Hess, Renato Cerqueira, Anand Ranganathan, Roy H. Campbell and Klara Nahrstedt, “Middleware Infrastructure to Enable Active Spaces,” IEEE Pervasive Computing, 74-83, October-December 2002.
4. Barry Brumitt, Brian Meyers, John Krumm, Amanda Kern and Steven Shafer,
“EasyLiving: Technologies for Intelligent Environments,” Proceedings of Handheld and Ubiquitous Computing (HUC), 12-18, Bristol, England, 2000.
5. Joao Pedro Sousa and David Garlan, “Aura: an Architectural Framework for User Mobility in Ubiquitous Computing Environments,” Proceedings of IEEE/IFIP Conference on Software Architecture, 29-43, Montreal, 2002.
6. Peter Tandler, “Software Infrastructure for Ubiquitous Computing Environments: Supporting Synchronous Collaboration with Heterogeneous Devices,” Proceedings of Ubicomp 2001: Ubiquitous Computing, 96-115, Atlanta, Ga., 2001.
7. Brad Johanson, Armando Fox and Terry Winograd, “Experiences with Ubiquitous Computing Rooms,” IEEE Pervasive Computing Magazine, 1(2), 67-74, 2002.
8. Robert Grimm, Janet Davis, Eric Lemar, Adam McBeath, Steven Swanson, Steven Gribble, Tom Anderson, Brian Bershad, Gaetano Borriello and David Wetherall,
“Programming for Pervasive Computing Environments,” University of Washington, Technical Report: UW-CSE-01-06-01, Washington 2001.
9. HAVi, http://www.havi.org, referenced in January, 2008.
10. Bodlaender, M. P. and Wendorf, R. G., “Adding full internet protocol functionality to HAVi,” Proceedings of the ICCE International Conference on Consumer Electronics 2001, 300-301.
11. Wendorf, R. G. and Bodlaender, M. P., “Remote execution of HAVi applications on internet-based devices,” Proceedings of the ICCE International Conference on Consumer Electronics 2001, 232-233.
12. “Jini Technology Architectural Overview,” http://www.sun.com/software/jini/whitepapers/architecture.html, referenced in Jan. 3, 2008.
13. “Jini Technology and Emerging Network Technologies,” http://www.sun.com/software/jini/whitepapers/technologies.html, referenced in Jan. 3, 2008.
14. “UPnP Technology—The Simple, Seamless Home Network,” http://www.upnp-ic.org/resources/white_papers, December 2006.
15. “The Ubiquitous Web, UPnP and Smart Homes,” http://whitepapers.zdnet.com/whitepaper.aspx?docid=174701&promo=100202, February 2006.
16. Amit Dhir & Saeid Mousavi, “Home Networking Using ‘No New Wires’ Phoneline and Powerline Interconnection Technologies,” http://www.xilinx.com/support/documentation/white_papers/wp133.pdf, Mar. 21, 2001.
17. Stephen S. Yau, Fariaz Karim, Yu Wang, Bin Wang and Sandeep K. S. Gupta, “Reconfigurabie Context-Sensitive Middleware for Pervasive Computing,” Arizona State University, IEEE PERVASIVE Computing, 2002.
18. Anand Ranganathan and Roy H. Campbell, “An infrastructure for context-awareness based on first order logic,” Personal and Ubiquitous Computing, 7:353-364, 2003.
19 Robert E. McGrath, Roy H. Campbell, M. Dennis Mickunas and Anand Ranganathan, “Use of Ontologies in a Pervasive Computing Environment,” The Knowledge Engineering Review, 18:3, 209-220, 2004, Cambridge University Press.
20. Anand Ranganathan, Jalal Al-Muhtadi and Roy H. Campbell, “Reasoning about Uncertain Contexts in Pervasive Computing Environments,” IEEE Pervasive Computing, 62-70, April-June 2004.
21. A. Ranganathan, R. Campbell, A. Ravi and A. Mahajan 2002, “ConChat: A
Context-Aware Chat Program,” IEEE Pervasive Computing, 52-58, July-September 2002.
22. Small, J., Smailagic, A. and Siewiorek, D., “Determining User Location For Context Aware Computing Through the Use of a Wireless LAN Infrastructure,” December 2000.
23. Tao Gua,b, Hung Keng Punga and Da Qing Zhang, “A service-oriented middleware for building context-aware services,” Network Systems and Services Laboratory, Department of Computer Science, National University of Singapore, 3 Science Drive, 2 Singapore 117543, Context-Aware System Department, Institute for Infocomm Research, Singapore, Jun. 4, 2004.
24. Anjum Shehzad, Hung Quoc Ngo, S. Y. Lee and Young-Koo Lee, “A Comprehensive Middleware Architecture for Context-Aware Ubiquitous Computing Systems,” Proceedings of the Fourth Annual ACIS International Conference on Computer and Information Science (ICIS'05) 2005.
25. Van Bunningen, A. H., Feng, L. and Apers, P. M. G, “Context for ubiquitous data management,” Ubiquitous Data Management, 4, 17-24, Apr. 2005.
26. Won Jeon and Klara Nahrstedt, “QoS-aware Middleware Support for Collaborative Streaming and Caching Service,” In Microprocessor and Microsystems Journal, Elsevier Publisher, Special Issue on QoS-enabled Multimedia Provisioning over the Internet, December 2002.
27. Xiaohui Gu and Klara Nahrstedt, “Dynamic QoS-aware Multimedia Service Configuration in Ubiquitous Computing Environments,” IEEE ICDCS 2002, 311-318
28. Tatsuya Yamazaki, “Ubiquitous Home: Real-Life Testbed for Home Context-Aware Service, National Institute of Information and Communications Technology,” First International Conference on Testbeds and Research Infrastructures for the DEvelopment of Networks and COMmunities (TRIDENTCOM'05), 54-59, japan 2005.
29. Yi Cui, Dongyan Xu and K Nahrstedt, “SMART: a scalable middleware solution for ubiquitous multimedia service delivery,” Multimedia and Expo, 2001. ICME 2001. IEEE International Conference on Publication, 1025-1028, 22-25 Aug. 2001.
30. Han-Sol Park, Da-Hye Choi, You-Hyeon Jeong and Tae-Uk Choi, “A CMQ Middleware Architecture for Multimedia Application in Ubiquitous Environment,” Advanced Communication Technology, 2006. ICACT 2006. The 8th International Conference, 1341-1345, 20-22 Feb. 2006.

What is claimed is:

1. An intelligent U-City middleware apparatus for realizing a service for a U-City system having plural sensors with individual sensor characteristics and plural ubiquitous remote resources with individual resource characteristics, the intelligent U-City middleware apparatus comprising:
a common device interface component receiving the individual sensor signals from the sensors and converting the received individual sensor signals to common sensor signals;
a context-aware computing component analyzing the common sensor signals to infer current context information of the u-city system; and
a ubiquitous core computing component receiving the context information from the context-aware computing module and configured to intelligently determine a service to be realized corresponding to the received context information.

2. The intelligent U-City middleware apparatus of claim 1, further comprising:
a common application interface component converting information related to the service, such that the information is compatible with any application executed in terminals with different operation environments, and providing the converted result to the terminals.

3. The intelligent U-City middleware apparatus of claim 2, wherein the ubiquitous core computing component comprises:
a Grid computing manager managing Grid computing functions.

5. The intelligent U-City middleware apparatus of claim 2, wherein the ubiquitous core computing component comprises:
a cloud computing manager managing cloud computing functions.

6. The intelligent U-City middleware apparatus of claim 2, wherein the context-aware computing module comprises:
a context repository storing context domains and context ontology instances;
a context interpreter receiving the common sensor signals and converting the received common sensor signals to context ontology instances;
a context aggregator combining the context ontology instances received from the context interpreter and providing a high-level context from low-level contexts;
a context analyzer inferring the context information from the high-level context by using predefined rules based on the domain ontology; and
a context provider providing the inferred context information to the ubiquitous core computing module.

7. The intelligent U-City middleware apparatus of claim 2, wherein the ubiquitous core computing component comprises:
a context manager receiving the context information and converting the context information to a format used for service discovery;
a service manager finding a service which best-matches the context information;
a task manager analyzing the services from the service manager and deploying the services to target systems; and
an environment manager setting communication environment parameters in response to a request from the task manager.

8. The intelligent U-City middleware apparatus of claim 2, wherein the ubiquitous core computing component comprises:
a computer based cooperative work functions which enable applications or services to be realized by the entities in a collaborative manner.

9. A U-City system having plural sensors with individual sensor characteristics and plural ubiquitous remote resources with individual resource characteristics, the U-City system comprising:
a feeling tier having the U-City infrastructure including sensors and remote resources;
an intelligent U-City middleware apparatus receiving individual sensor signals from the feeling tier, inferring current context information of the U-City system from the received sensor signals, and determining and realizing a service to be executed corresponding to the context information in an intelligent manner; and
a presentation tier allowing having human computer interaction and, therefore, displaying information related to the service and configured to allow the intelligent U-City middleware apparatus to control the remote resources, wherein the intelligent U-City middleware apparatus comprises:
a common device interface component converting the individual sensor signals received from the feeling tier to common sensor signals;
a context-aware computing component analyzing the common sensor signals to infer current context information of the u-city system;
a ubiquitous core computing component receiving the context information from the context-aware computing module and configured to intelligently determine the service to be realized for the u-city system corresponding to the received context information; and
a common application interface component converting information related to the service, such that the information is compatible with any application executed in terminals with different operation environments, and providing the converted result to the terminals.

10. The U-City system of claim 9, the context-aware computing module comprising:
a context repository storing context domains and context ontology instances;
a context interpreter receiving the common sensor signals and converting the received common sensor signals to context ontology instances;
a context aggregator combining the context ontology instances received from the context interpreter and providing a high-level context from low-level contexts;
a context analyzer inferring the context information from the high-level context by using predefined rules based on the domain ontology; and
a context providing the inferred context information to the ubiquitous core computing module.

11. The U-City system of claim 9, wherein the ubiquitous core computing module comprises:
a context manager receiving the context information and converting the context information to a format used for service discovery;
a service manager finding a service which best-matches the context information;
a task manager analyzing the services from the service manager and deploying the services to target systems; and
an environment manager setting communication environment parameters in response to a request from the task manager.

12. The U-City system of claim 9, wherein the ubiquitous core computing component comprises:
a Grid computing manager managing Grid computing functions.

13. The U-City system of claim 9, wherein the ubiquitous core computing component comprises:
a cloud computing manager managing cloud computing functions.

14. The U-City system of claim 9, wherein the ubiquitous core computing component comprises:
a computer based cooperative work functions which enable applications or services to be realized by the entities in a collaborative manner.
